(19) United States
(12) Patent Application Publication
(10) Pub. No.: US 2015/0174580 A1
(43) Pub. Date: Jun. 25, 2015

(54) MEANS FOR SECURING JAW PLATES IN A JAW CRUSHER

(71) Applicant: SANDVIK INTELLECTUAL PROPERTY AB, Sandviken (SE)

(72) Inventors: Marten Lindberg, Malmo (SE); Karin Ljunggren, Limhamm (SE); Roger Sjobeck, Malmo (SE)

(21) Appl. No.: 14/406,584

(22) PCT Filed: May 27, 2013
(86) PCT No.: PCT/EP2013/060837

§ 371 Date: Dec. 9, 2014

(30) Foreign Application Priority Data
Jun. 13, 2012 (EP) 12171784.7

(51) Int. Cl. B02C 1/10

(52) U.S. Cl. CPC B02C 1/10

(57) ABSTRACT

A jaw plate part for securing jaw plates to a jaw crusher of the jaw crusher can be arranged to work as a wedge being detachable from the jaw crusher. The jaw plate part includes a front face and a rear face. The rear face of the jaw plate part has at least one recess having a first dead end. The recess, in at least one region, includes a shoulder, wherein a width of the recess at least closest to the shoulder on a side of the shoulder facing the first dead end is larger than the width of the recess at least closest to the shoulder on a side of the shoulder facing the rear face. The invention also concerns a jaw plate part unit having at least one such jaw plate part and fastening means. Moreover, the invention also concerns a jaw crusher having at least one jaw plate part unit for securing jaw plates of the jaw crusher.

### TECHNICAL FIELD OF THE INVENTION

The present invention relates to a jaw crusher used for crushing, and can be suitably used in the construction and mining industries.

### BACKGROUND ART

When crushing of hard material, e.g. stone blocks or ore blocks, different types of crushers may be used. One example of a type of crushers is jaw crushers of which a typical jaw crusher includes a stationary jaw and a movable jaw spaced to define a crushing chamber in between. The material to be crushed is fed into the crushing chamber and is crushed by the face of each of the jaws as the movable jaw is moved repeatedly toward and away from the stationary jaw.

The jaws of the crusher experience tremendous forces and wear, but also vibrations during crushing. Hence, the jaws are equipped with die plates for wear protection of their faces, i.e. outer die plates called jaw plates working as both wear protection and crushing surfaces in contact with the material to be crushed and intermediary or shim die plates placed between the outer jaw plates and the jaws for protecting the jaw from wear by means of the outer jaw plates as the outer jaw plates otherwise may rub against the jaw during operation of the crusher. The outer wear protecting and crushing jaw plates of the jaws must be secured in place by known rigid solid metal wedges clamping the jaw die plate securely to the respective jaw by wedging against end surfaces of each jaw plate and jaw of the crusher. These prior art solid metal wedges are commonly attached to each jaw by means of threaded pull, tension or tie rods inserted into through holes/bores protruding through the whole thickness of each known solid metal wedge and each jaw and then having nuts threaded onto the rods at the other end of the jaw until a pre-defined prestress or moment of a force is reached for releasably securing the known solid metal wedge to the underlying jaw and crusher. In some cases, when the metal wedge is a jaw die plate working as a separate jaw die plate similar to a lengthening piece between two jaw die plates with the same dimension and shape but having a smaller height compared to the two adjacent jaw die plates, these jaw die plates including the shorter lengthening jaw die plate are also attached to each jaw by means of threaded pull, tension or tie rods inserted into through holes/bores protruding through the whole thickness of each known solid jaw die plate and each jaw similar to attaching the wedges.

A combination of metal and rubber washers is placed between the nut and the jaw to distribute the prestress and forces in a common way for hindering unwanted slackening of the screw.

As the jaw die plates and the known solid metal jaw plate clamping wedges are objected to wear, they have to be replaced when worn out, hence, they must have the ability to be easily mounted and dismounted from the crusher.

Each of the jaw die plates and the known solid metal jaw plate clamping wedges are casted in one piece being heavy and cumbersome to handle and are provided with holes passing through the whole thickness of the known solid metal jaw plate clamping wedges and parts of the jaw die plates between their front facing the crusher chamber and their rear facing the jaw for enabling the introduction of the threaded tie rods. More than one clamping wedge may be required to hold a jaw plate in place in the crusher, and, in some cases, a jaw plate can be divided in more than two-parts, i.e. two or more jaw plate parts having the same or different dimensions, e.g. a smaller height as the lengthening piece, each part being casted in one piece, are used for making up one and the same whole jaw plate in the crusher. The same goes for the clamping wedges.

Hence, the known solid metal clamping wedges and the different jaw plate parts have fronts with exposed orifices of the through holes facing and being exposed to the crushing chamber, which orifices receive the heads of the tie rods, often screw heads. The orifices and screw heads are exposed to the material to be crushed when the material is fed down the crushing chamber, whereby the orifices and screw heads are weared down at the fronts of the jaw die plates and the clamping wedges together with the surrounding area of their fronts deadlocking the screw heads of the tie rods of the jaw plate parts and the clamping wedges onto the jaw, wherefore these prior art solid metal jaw plate parts and clamping wedges must be cut away by using a cutting torch. In some cases, elongated objects, such as reinforcement bars, may unfortunately land with their ends in the exposed orifices of the through holes on the face of the clamping bars or the jaw die plates, if two-part jaw die plates and/or jaw die plates working as lengthening pieces are used facing and being exposed to the crushing chamber, which reinforcement bars end up in a “standing up” position inside the crusher during its operation creating severe crushing problems.

### SUMMARY OF THE INVENTION

It is an object of the invention to provide a jaw plate member being a part or portion of a jaw plate and/or a separate clamping bar working as a wedge, the wedge or jaw plate part being easily assembled in and removed from a jaw crusher, which solve, or at least lessen, the problems mentioned above and below.

Another object of the invention is to provide a jaw plate part being a jaw plate clamping bar or to use at least one the jaw plate part in combination with at least one jaw plate clamping bar.

It is an object of the invention to provide a jaw plate part creating a wear protection of the front of the jaw plate part facing the crushing chamber, which front is adapted to cover fastening means at the rear of the jaw plate part. Then the fastening means are protected against wear but also protected against being “smeared out” as the material being crushed otherwise hammers on both the jaw plate front and the fastening means, if exposed to the material to be crushed as in prior art, deforming the fastening means or more specifically deforming the heads of the fastening means by wearing them down and “smearing” them out into shapes similar to tack or pan headed rivets instead of their original and non-deformed screw head shape.

Another object of the invention is to provide a jaw plate part with an improved wear resistance reducing the need of replacing the jaw plate part when its front is weared down too “far” or even weared out and eliminating or at least reducing the need of cutting away its fastening means by using torches during the operation of the jaw crusher.

One other object of the invention is to provide a jaw plate part with an improved wear resistance reducing the need of any manual effort demanding cutting away of its fastening means by using torches when replacing the jaw plate part when its front is weared down too “far” or even weared out during the jaw crusher operation.

Yet another object of the invention is to provide a jaw plate part which maintains a secure clamping of the jaw plate during a longer period of time compared to prior art jaw plate parts prolonging the operation time of the jaw crusher by reducing the need of standstills for replacement of such jaw plate parts as the wear resistance of the jaw plate part is improved due to the fact that the jaw plate parts do not have to be replaced as often as before.

Still another object of the invention is to provide a jaw plate part making it possible to keep the same dimensions, shapes, structure and sizes of the adjoining parts of the jaw crusher, i.e. the jaw plate and the jaw, simplifying the construction of jaw crushers but also simplifying the renovation of old crushers as worn out prior art jaw plate parts or prior art solid metal wedges for holding and/or clamping the jaw plates in place can be easily replaced by the inventive jaw plate part.

Another object of the invention is to provide a jaw plate part that reduces the number of times it and its fastening means have to be replaced due to too much wear of them during the operation of the jaw crusher, whereby the associated number of standstills of the crusher to be able to replace the worn out front of the jaw plate part and its fastening means if necessary is also reduced, the same goes for the associated effort for this maintenance.

Yet another object of the invention is to provide a jaw plate part that simplifies the assembly of the jaw plate part as the jaw plate part has the ability to be easily hanged on exposed front parts, e.g. heads of its fastening means protruding out past the jaw, without having to take careful aim of the heads of the fastening means for fitting them into through holes of the jaw plate part.

Another object of the invention is to provide a jaw plate part that reduces the effort for the operators handling these jaw plate parts during the assembly and disassembly of the jaw plate parts in the crusher by enabling the jaw plate part to be easily fitted onto the fastening means by hanging it thereon but also to be easily lifted away or removed from the fastening means when replacing the heavy jaw plate part by hand.

These objects are achieved by means of a jaw plate part, a jaw plate part unit comprising a jaw plate part with assembled fastening means and a jaw crusher comprising at least one such jaw plate part or jaw plate part unit as claimed in the associated independent claims, preferred variants thereof being defined in the associated dependent claims.

The jaw plate part according to the independent jaw plate part claim makes it possible to improve the wear resistancy of the jaw plate part as its front has no through holes being exposed to and facing the crushing chamber.

The jaw plate part according to the independent jaw plate part claim makes it possible to simplify the assembly and disassembly of the jaw plate part to and from the crusher as its design with at least one recess makes it easier to hang up and take down the jaw plate part from its fastening means.

The jaw plate part according to the independent jaw plate part claim makes it possible to improve the fastening/clamping ability of the jaw plate part bar as the need of replacing it due to too much wear of its front and its fastening means is reduced.

In some embodiments/aspects, the first dead end of the jaw plate part ends at a distance from the front face eliminating any exposed through holes in the front face of the jaw plate part being more sensible to wear so that the thereby closed front of the jaw plate part resists wear in an improved way.

In one embodiment/aspect, the recess of the jaw plate part has a cross section being T-shaped. In another embodiment/aspect, the recess is a groove extending along the rear face with its first dead end at a distance from the front face. In yet another embodiment/aspect, the width of the recess of the jaw plate part on the side of the shoulder facing the dead end is larger than the width of the recess on the side of the shoulder facing the rear face. In still another embodiment/aspect, the groove/recess of the jaw plate part comprises two ends defining the length of the groove, wherein one of the groove ends is a second dead end. In one other embodiment/aspect, the other end of the groove of the jaw plate part is an open end. In another embodiment/aspect, the recess of the jaw plate part is adapted to receive fastening means for the jaw plate part, which fastening means comprises one pin with a head, wherein the shoulder acts as an abutment for the pin head. In still another embodiment or aspect, the pin head of the fastening means is arranged in the recess of the jaw plate part on the side of the shoulder facing the first dead end where the width of the recess is larger. In another embodiment/aspect, the pin of the fastening means protrudes out of the recess of the jaw plate part in a direction not being in parallel with the lengthwise extension of the recess. In yet another embodiment/aspect, the pin protrudes out of the recess of the jaw plate part passing the side of the shoulder facing the rear face where the width of the recess is smaller. In one other embodiment/aspect, the recess on the side of the shoulder facing the first dead end has a fit in relation to the pin head creating a rotational lock for the pin head. In another embodiment/aspect, the recess fit is created by the width of the recess of the jaw plate part being adapted to the width of the pin head for achieving the rotational lock by tightly fittable shapes. In still another embodiment/aspect, the front face of the jaw plate part is a fully covered or sealed or closed surface. In yet another embodiment/aspect, the front face of the jaw plate part is smooth or even all over where the jaw plate part faces the crusher chamber of the jaw crusher.

According to the invention and any embodiment, the jaw plate part is a jaw plate clamping bar or at least one jaw plate part is used in combination with at least one jaw plate clamping bar.

Any or some of the above embodiments/aspects, reduce/-s the cumbersome and heavy lifting and handling of the jaw plate part and/or the clamping bar by operators assembling and disassembling these in jaw crushers compared to known jaw plate parts and known jaw plate clamping bars. Any or some of the above embodiments/aspects, improve/-s the wear resistance and actual life of the inventive jaw plate part and jaw plate clamping bar before it has to be replaced due to wearing out and prolongs the accessibility of the key handles of the fastening means as those are not worn out as fast as in prior art. Any or some of the above embodiments/aspects of the invention, reduce/-s the wear of the fastening means and the actual life of the fastening means before it has to be replaced due to wearing out and also improves the accessibility of the key handles of the fastening means when being unscrewed.

The jaw plate part and the jaw plate part unit to be used in a jaw crusher according to the independent claims make it possible to increase the life time of both the jaw plate part itself but also its fastening means by increasing the wear resistance, which reduces the number of necessary standstills for replacement of jaw plate parts and their fastening/clamping means being weared down too “far”. Moreover, by reducing the need of replacing the jaw plate parts and their fastening means during the operation of the jaw crusher, the number of necessary standstills for such maintenance is also reduced increasing the effective operation time of the jaw crusher.

In some embodiments/aspects, the jaw plate part and the jaw plate part unit make it possible to simplify the manufacturing and handling of manufactured jaw plate parts and to reduce the cost of handling of these and to simplify the assembly of the jaw plate part and its fastening means to each jaw plate as the jaw plate part is easier to mount/hang onto its fastening means when assembled into the jaw crusher but also easier to dismount from its fastening means when removing the jaw plate part from the crusher.

The effect of the invention is that the improved wear resistancy of the jaw plate part increases the life time of the jaw plate part. The effect of the invention is that the improved wear resistancy of the jaw plate part reduces or even eliminates the wearing down and “hammering” or “smearing out” of the fastening means of the jaw plate parts as the material being crushed and hammering on the front of the jaw plate part does not hammer directly onto the fastening means anymore, whereby no wear and/or no “riveting” of the fastening means of the jaw plate part occurs. The effect of the invention is that the assembly and disassembly of the jaw plate part is simplified as the design of the jaw plate part makes it possible to easily hang the jaw plate part onto its fastening means in the similar way as hanging up a painting on a nail/screw on a wall and to remove the jaw plate part in the similar way as taking down that painting. This makes it possible to improve and simplify the manual holding, handling, assembly and replacement of the jaw plate part in a less effort demanding and therefore more secure way in the jaw crusher.

### BRIEF DESCRIPTION OF THE DRAWINGS

The invention will be described in more detail with reference to the appended drawings, which show examples of presently preferred embodiments of the invention.

FIGS. 1 and 2 shows a jaw crusher in two different enlargements with jaws comprising at least one jaw plate part and/or at least one clamping bar according to the invention,

FIG. 3 is a perspective view of the jaw plate part and/or the clamping bar according to the invention and one way of detachably attaching it to the jaw,

FIG. 4 is a perspective rear view showing the jaw plate part and/or the clamping bar of FIG. 3,

FIG. 5 is a rear view showing the jaw plate part and/or the clamping bar according to the invention,

FIG. 6 is a bottom view showing the jaw plate part and/or the clamping bar according to FIGS. 3 to 5,

FIG. 7 is a view in cross-section showing the jaw plate part and/or the clamping bar according to FIGS. 3 to 6 in profile, and

FIGS. 8 and 9 are views in cross-section showing the jaw plate part and/or the clamping bar in other versions according to the invention similar to FIGS. 3 to 7.

### DETAILED DESCRIPTION OF THE INVENTION

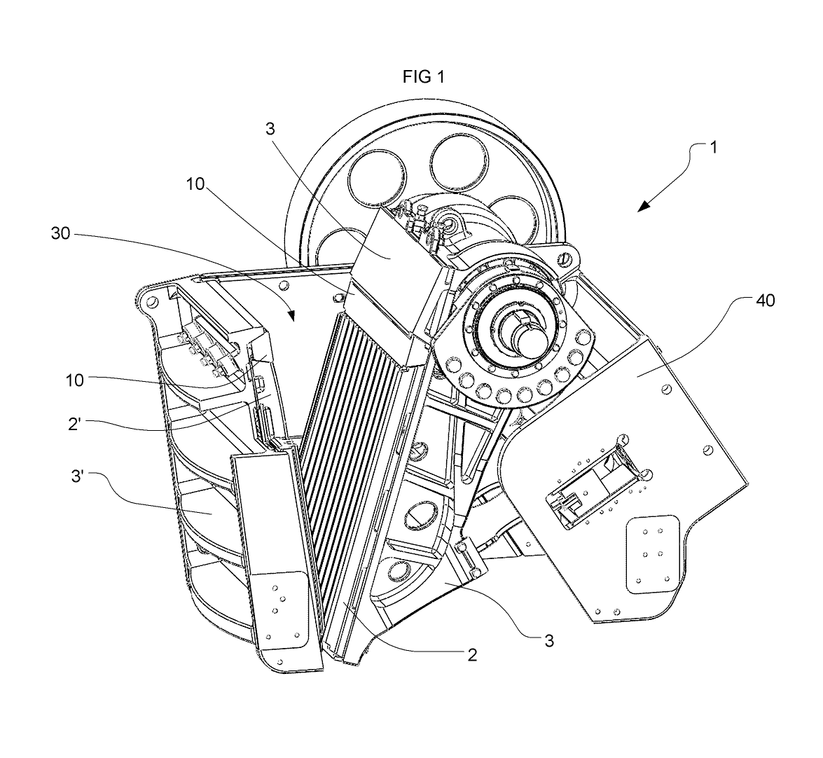

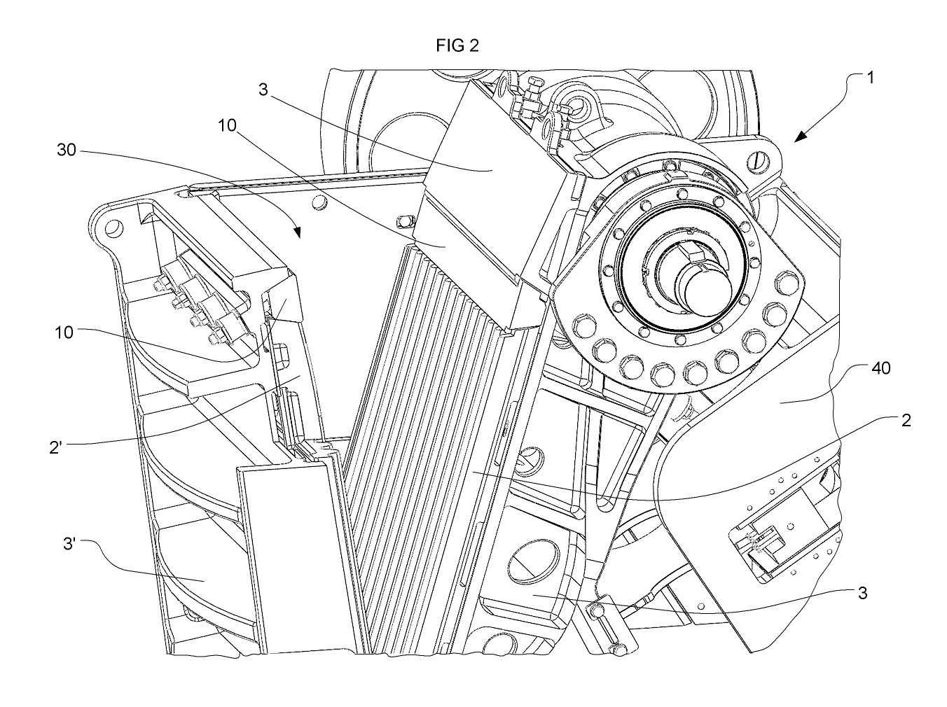

A jaw crusher 1 is shown in FIGS. 1 to 2. The jaw crusher comprises jaw plates 2, 2′ and a moving jaw 3 and a stationary jaw 3′, each jaw being provided with at least one jaw plate 2, 2′. The jaw plates are securely retained against each jaw 3, 3′ by means of clamping bars 10 and/or other jaw plate parts if the jaw plates are divided into more than one part, similar to a lengthening or widening jaw plate part or piece. Such a lengthening jaw plate part 10 does not necessarily have the function of a clamping bar but could of course have this function or be used in combination with at least one clamping bar 10. Such a lengthening jaw die plate 10 may have the same height as the adjacent jaw die plates or another height, e.g. a smaller height measured in the vertical or material feeding direction of the crusher. Each jaw 3, 3′ or jaw plate 2, 2′ comprises an upper surface 4 being slanted for defining a wedge surface against which the jaw plate part/clamping bar 10 wedges for securely clamping the jaw plate in place in the crusher (see FIGS. 1, 2 and 9). Each jaw 3, 3′ or jaw plate 2, 2′ comprises a lower surface 5 being slanted for defining an anvil surface against which the clamping bar wedges for securely clamping the jaw plate 2, 2′ in place in the crusher 1 (see FIGS. 1, 2 and 9). The upper and lower surfaces 4 and 5 are defined in view of FIG. 9 and can be seen also in FIGS. 1 and 2 even though these surfaces are not shown with numerals in FIGS. 1 and 2.

Each jaw plate part/clamping bar 10 is detachably attached to the associated jaw 3, 3′ by fastening means 50, e.g. in the form of threaded tension rods (shown as long screws working as tension rods) passing through the jaw with nuts threaded onto their other ends and/or screws/bolts threaded directly onto threaded holes (not shown). A similar fastening is used for the different parts of a jaw plate when the jaw plate is made up of at least two separate jaw plate parts 10. The crusher 1 has its stationary 3′ and movable jaw 3 spaced to define a crushing chamber/gap 30 in between the jaws.

The jaw crusher 1 of FIGS. 1 and 2 has a frame 40, which comprises a frame portion with rotary drive means for repeatedly moving the movable jaw 3 (shown to the right in FIGS. 1 and 2) toward and away from the stationary jaw 3′ (shown to the left in FIGS. 1 and 2) and a frame portion comprising means for securing the jaws. These parts of a jaw crusher 1 and their function are readily known by a skilled person and will not be explained in more detail. Each jaw 3, 3′ comprises the wedging surface 4 adapted to cooperate with the inventive jaw plate part/clamping bar 10. Each jaw plate 2, 2′ comprises the wedging surface 5 also being adapted to cooperate with the inventive jaw plate part/clamping bar for securing the plate in place.

The inventive jaw plate clamping bar 10 as shown in FIGS. 1 to 9 has an outer shape or contour corresponding to a wedge and is shown during assembly/disassembly to/from its placement between a jaw plate 2, 2′ and a jaw 3, 3′, i.e. between and above the upper portion of a jaw plate, i.e. wedging surface 4, and the lower portion 5 of a jaw, i.e. wedging surface 5.

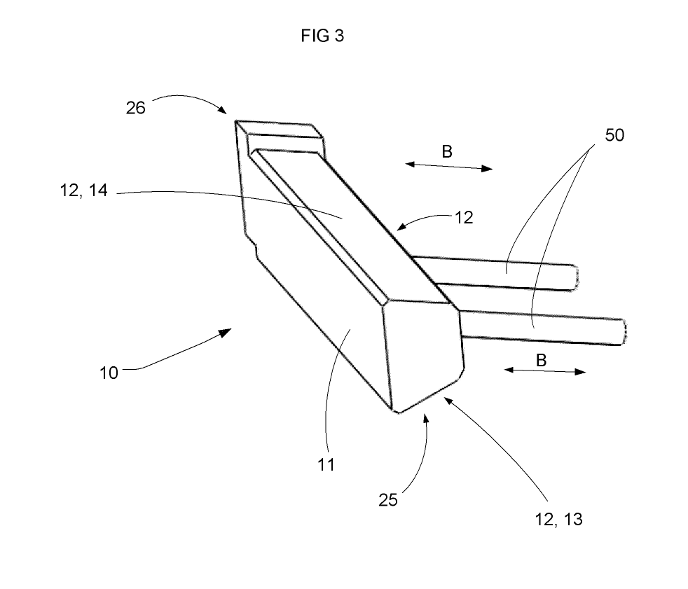

The proportions of the shown varying shapes and dimensions in FIGS. 3 to 9 of the inventive clamping bar 10 are more or less exaggerated or reduced to enlighten the principle of the inventiveness of the jaw plate clamping bar 10. The jaw plates being made of more than one part also has their different jaw plate parts shaped as wedges with slanted surfaces for supporting against each other, however, these separate jaw plate parts usually do not work as clamping wedges as their back surface usually bottoms against the jaws 3, 3′ or the shim plates, i.e. the intermediary jaw die plates, after being attached to the jaws in “stationary” contact with the jaws compared to the clamping bars having their back surface at a distance from each jaw when assembled in the crusher to be able to maintain a sufficient clamping even though it moves towards and away from the jaw in response to varying loads on the clamping bar when the crusher operates.

The improved wear resistance and assembly simplifying ability of the inventive jaw plate part and/or clamping bar 10 means that the retaining of the jaw plates 2, 2′ is improved and simplified as less effort is required when mounting the separate jaw plate parts and/or the clamping bar into a crusher 1 and a lesser number of replacements of the separate jaw plate parts and/or the clamping bar itself but also its fastening means are required, wherefore also the trouble with narrow spaces behind the jaws 3, 3′ in the crusher making the accessibility of the fastening means very low is reduced as less subsequent unscrewing and tightening of the fastening means is needed during operation of the jaw crusher 1.

The number of jaw plate parts and/or clamping bars 10 depends on the size of the crusher 1 and its jaw plates 2, 2′, i.e. the width of the jaw crusher and its plates and may be between one, two, three and more, or preferably either one jaw plate part/clamping bar or two jaw plate parts/clamping bars for each jaw plate. In one example, one jaw plate 2 is arranged on the moving jaw 3 and one jaw plate 2′ is arranged on the stationary jaw 3′, each jaw plate comprising one jaw plate part/clamping bar 10. In an example (not shown), each jaw plate comprises two or more jaw plate parts/clamping bars 10.

The inventive jaw plate clamping bar 10 has a wedge-shaped outer contour in profile and in cross-section, as shown in FIGS. 1 to 4, and 7 to 9, and is an elongated item, but may of course have a length close to or equal to its width in cross-section or profile seen in FIGS. 3 and 7 to 9. The jaw plate clamping bar 10 may also have a length being shorter, i.e. smaller than its width, however, a length being larger than its width is the most preferred dimensional proportion making the clamping bar elongated.

Each of the jaw plates 2, 2′ and the known solid metal jaw plate parts/clamping wedges 10 have hitherto been casted in one piece, whereby they always are heavy. The jaw plates 2, 2′ may be divided into at least two parts, whereby at least one joint is created between these two jaw plate parts, which joint then would have to be secured in the similar way as the ends of the jaw plates, e.g. by further jaw plate parts 10, which jaw plate parts do not have an adaptable clamping ability as explained above. In this case, the description is focused on the clamping of the jaw plates at their “free” ends and not their ends at the joint between their separate jaw plate parts by means of the jaw plate clamping bars but touch upon the joint of at least one two-part jaw plate with at least one lengthening and/or widening jaw plate part 10 for joining the two parts of the jaw plate 2, 2′. This lengthening and/or widening jaw plate part 10 has the same inventive features, e.g. shape, material, and size, as the jaw plate clamping bar 10 except for the clamping function of the bar as explained above and the shape of the front face towards the crushing chamber as the jaw plate part 10 may comprise a closed surface having a wave or teeth shape giving a corrugated or grooved front facing the crushing chamber, which waves/teeths correspond to the known pattern of the front face of the jaw plates 2, 2′.

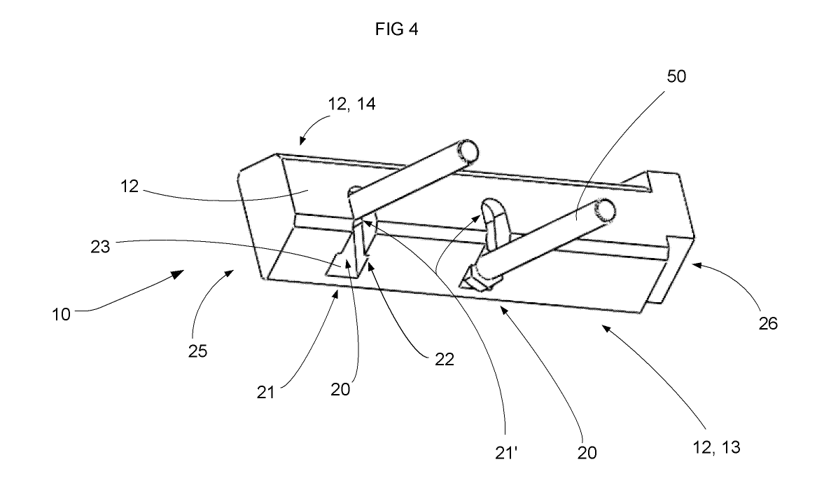

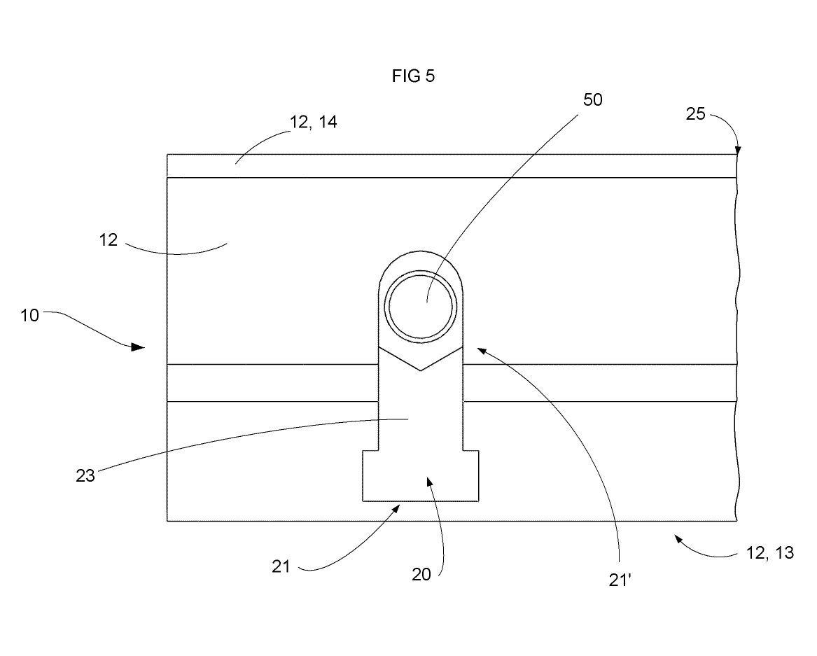

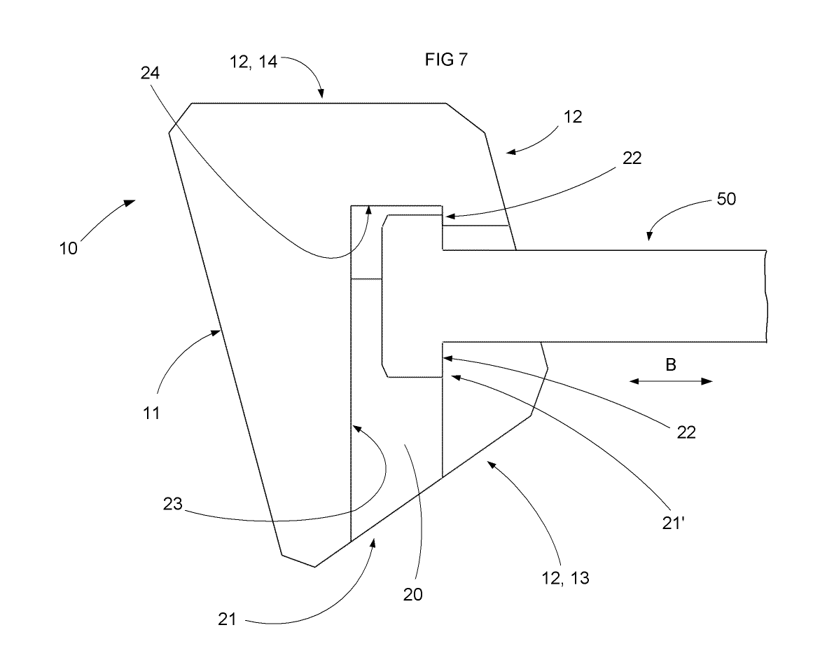

The jaw plate clamping bar 10 may be made of a metallic material having a shape with an upper 12, 13 and a lower 12, 14 portion diverging from each other. The portions define partly at least one inner recess 20 being an open cavity/space between each other (see FIGS. 4 to 9) when viewing the cross section of the clamping bar in FIGS. 7 to 9. In FIGS. 4 to 6, the recess 20 is shown as at least two recesses separated from each other, but may of course be more than two. The recess 20 between the lower and upper portions 12, 13, 14 opens on to the jaw 3, 3′ in directions extending from the crushing chamber 30 of the jaw crusher 1. The recess 20 has a first opening 21 at the lower portion 12, 13 of the clamping bar 10. The recess 20 has a second opening 21′ at the rear 12 of the clamping bar 10. These openings 21, 21′ form orifices of the clamping bar facing or leading out in different directions for receiving heads of the fastening means 50 as shown in FIGS. 3 to 9. However, the openings 21 and 21′ are adjoining orifices, i.e. they form in principle one and the same opening in this embodiment or a “common” opening that can be seen as “opening up” in at least two directions. The first opening 21 faces substantially downwards towards the bottom 12, 13 of the clamping bar but could in some versions face upwards, even though the downward direction is preferred for enabling an easy “hanging up” of the clamping bar 10. The second opening 21′ faces substantially downwards towards the bottom 12, 13 of the clamping bar but could in some versions face upwards and/or backwards in relation to a front 11 of the jaw plate part/clamping bar, even though the downward direction is preferred for enabling an easy “hanging up” of the clamping bar 10. These opening 21, 21′ could also be shaped as a key hole when viewing the clamping bar from the rear as in FIG. 5 with the lower opening 21 being larger than the upper opening 21′.

The upper jaw plate clamping bar portion 13 of the jaw plate clamping bar 10 comprises an upper contact surface and the lower jaw plate clamping bar portion 14 comprises a lower contact surface with an angle between these surfaces for forming the wedging portions of the clamping bar 10.

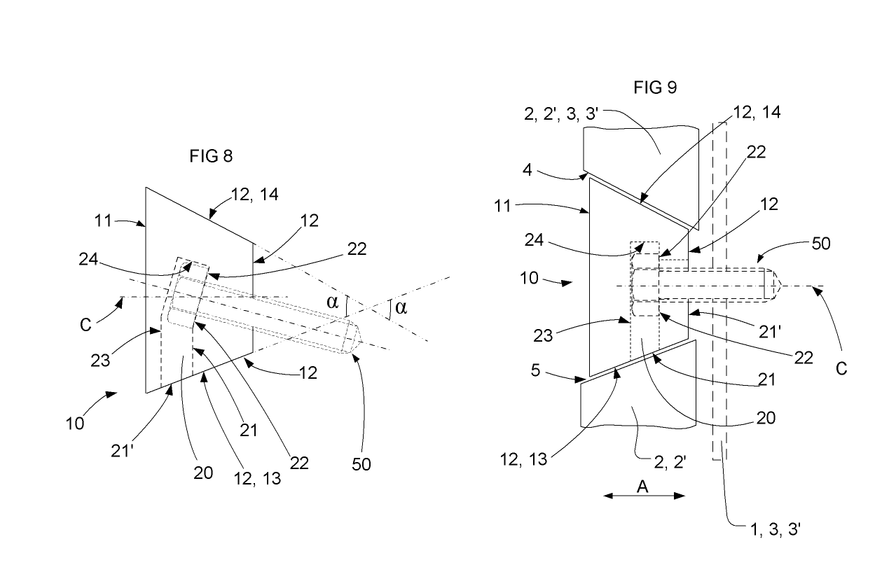

The jaw plate clamping bar 10 comprises, when studied in profile, a first back portion 12, a second lower portion 13 and a third upper portion 14 with an angle α between these portions 13, 14. However, as seen in FIG. 8, the lower and upper portions 13 and 14 are extended with dotted and dashed lines that coincide seen in the direction from the front 11 to the rear 12 of the clamping bar meaning that the rear of the clamping bar may be formed by only the back portion 12 having an upper and lower portion coinciding further back as a longer wedge and not having a cross section similar to a truncated cone when viewing the clamping bar 10 from the side as shown in FIGS. 3, 4, 7 and 9: The jaw plate clamping bar 10 is releasably attached to the underlying jaw 3, 3′ by means of the detachable fastening means 50 being introduced through the intermediary portion or back portion 12 of the jaw plate clamping bar forming an adjoining corner area between the end areas of the upper and lower portions 14 and 13 as shown in FIGS. 3 to 9. The wedge shape of the jaw plate clamping bar 10 means that the jaw plate clamping bar can be moved in and out, i.e. in both directions of the arrows B shown adjacent the fastening means 50 in FIGS. 3 and 7 towards the jaw 3, 3′ and away from the jaw depending on how far it is pulled in by the fastening means and how far and in which direction it moves during the operation of the jaw crusher 1. In FIG. 9, another arrow A shows the same direction as arrow B if the centre axis C extend straight through the clamping bar while the direction of arrow A indicating the movement of the clamping bar 10 may in some cases differ from the direction of arrow B being in parallel with the centre axis of the fastening means 50 extending somewhat obliquely in relation to the centre axis C. However, the direction of arrow A may also differ from the direction of the centre axis C or be in parallel with the centre axis C. The back portion 12 is not supposed to be in contact or to abut against the jaw or jaw crusher 1 as it then may be a risk of non-tensioning, i.e. slacking of the fastening means 50 and lost clamping ability, i.e. the distance between the back portion 12 of the jaw plate clamping bar 10 and the associated surface of the jaw crusher 1 as shown in FIG. 9 is required to maintain and create a tension in the fastening means 50 enabling the clamping.

The jaw plate clamping bar 10 may be formed in only one layer/element 11, i.e. one piece, as shown in FIGS. 7, 8 and 9.

The jaw plate clamping bar 10 as shown in FIGS. 1 to 3, 7, 8 and 9 is fully covered over its whole outer and/or front surface by a wear protecting layer for closing the front face or front or front surface 11, which wear protecting layer may be a separate part, but is preferably a fully integrated part of the jaw clamping bar 10, i.e. its front 11.

FIGS. 3 to 8 show a view in cross-section over the jaw plate clamping bar 10 in another version similar to FIG. 9. Here, the jaw plate clamping bar 10 is detachably attached to the jaw crusher 1 by using somewhat obliquely extending fastening means 50 in relation to the centre axis C of the clamping bar. The centre axis C extends in parallel with the plane of FIGS. 8 and 9 but is perpendicular to a longitudinal axis of the clamping bar extending perpendicularly to the plane of FIGS. 8 and 9.

In some cases, the upper wedge surface 4 and the lower wedge surface 5 may be parts of a jaw plate 2, 2′ if the jaw plate clamping bar 10 is arranged in a joint between two-parts of a jaw plate, and, in other cases, the upper wedge surface 4 may be the lower surface of a deflector plate having no numeral in this description as it is a part of the jaw 3 to the right in FIGS. 1 and 2 and shown as the upper most slanting surface above the jaw plate clamping bar where the drawn line from the upper numerals 3, 3′ end. Hence, these wedging surfaces 4 and 5 work as complementary anvil/seat portions cooperating with portions and surfaces of the jaw plate clamping bar.

The invention also concerns the jaw crusher 1 comprising at least one jaw plate clamping bar 10 according to the above description for securing at least one jaw plate 2, 2′ of the jaw crusher.

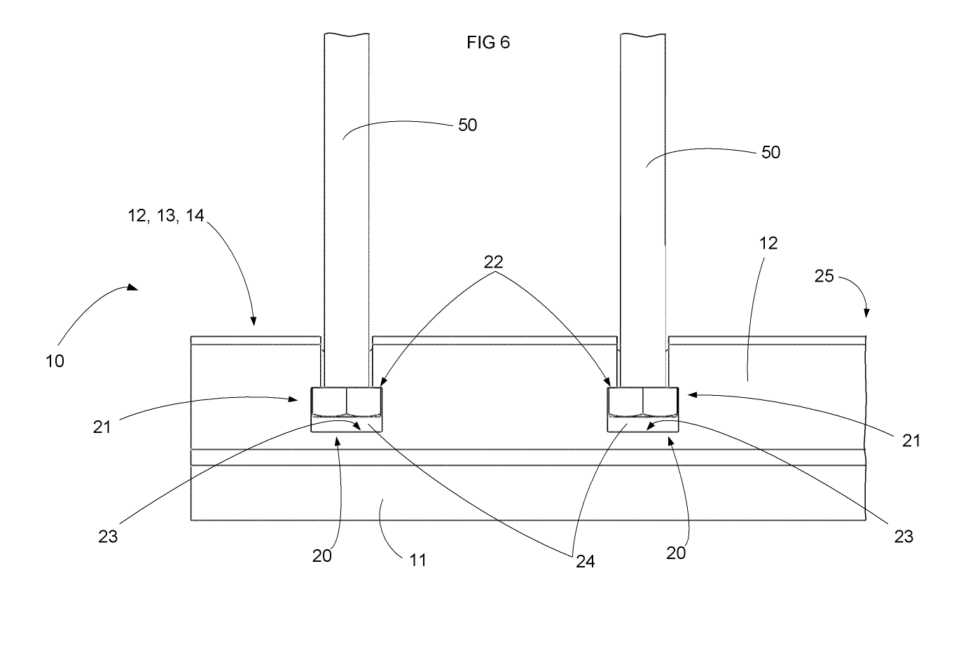

The jaw plate clamping bar 10 comprises the front face 11 and the rear face 12, 13, 14. The rear face being either only the rear 12 or a combination of the rear 12 and the lower and/or the upper portions 13 and/or 14 comprises at least one recess 20 having a first dead end 23. The recess, in at least one region, as shown in FIGS. 6 to 9, comprises a shoulder 22. A width of the recess 20 at least closest to the shoulder 22 on the side of the shoulder facing the first dead end 23 is larger than the width of the recess at least closest to the shoulder on the side of the shoulder facing the rear face 12, 13, 14. The first dead end 23 ends at a distance from the front face 11. The first dead end 23 extends substantially along the front face 11 of the clamping bar. The first dead end 23 ends at a distance from the front face 11 such that no through opening is formed on the front face of the clamping bar 10 where objects may get stuck.

The recess 20 has a cross section being T-shaped as shown in FIGS. 5 and 6. The recess 20 is a groove extending along the rear face 12, 13, 14 with its first dead end 23 at a distance from the front face 11. The width of the recess 20 on the side of the shoulder 22 facing the first dead end 23 is larger than the width of the recess on the side of the shoulder facing the rear face 12, 13, 14. The groove 20 comprises two ends defining the length of the groove, wherein one of the groove ends is a second dead end 24. The other end of the groove is an open end and corresponds to the opening 21. The second dead end 24 is arranged at distance from the upper portion 12, 14. The recess 20 is adapted to receive the fastening means 50 for the jaw plate clamping bar 10, which fastening means may comprise one pin with a head, preferably a screw head. The shoulder 22 acts as an abutment for the pin head of the fastening means.

The pin head of the fastening means 50 is arranged in the recess 20 of the clamping bar 10 on the side of the shoulder 22 facing the first dead end 23 where the width of the recess is larger. The pin of the fastening means 50 protrudes out of the recess 20 in a direction not being in parallel with the lengthwise extension of the recess. The pin of the fastening means protrudes out of the recess 20 passing the side of the shoulder 22 facing the rear face 12, 13, 14 where the width of the recess is smaller. The recess 20 of the clamping bar 10 on the side of the shoulder 22 facing the first dead end 23 has a fit shown in FIG. 6 in relation to the pin head creating a rotational lock for the pin head of the fastening means 50. This recess fit is created by the width of the clamping bar recess 20 being adapted to the width of the pin head.

The front face 11 of the jaw plate clamping bar 10 is a fully covered or sealed or closed surface that in principle forms a wear protective integrated lid over the heads of the pins of the fastening means 50. Hence, the front face 11 of the jaw plate clamping bar 10 is smooth/even all over where the jaw plate clamping bar faces the crusher chamber 30 of the jaw crusher 1. Moreover, at least one jaw plate clamping bar 10 and at least one fastening means 50 together form a jaw plate clamping bar unit.

The recess 20 has a greater width at the first dead end 23 than closer to the rear face 12, 13, 14, i.e. past the shoulder 22 towards the rear portions 12, 13, 14. The recess 20 has a depth being smaller than the distance between the front face and the rear face, i.e. the depth of the recess is smaller than the thickness of the clamping bar 10 measured in the direction of extension of the fastening means 50. The front face 11 faces the crushing chamber 30. The rear face 12, 13, 14 may be one, two or more rear portions that extend and coincide at their end points as shown in FIG. 8. The second dead end 24 extends perpendicular or at least obliquely in relation to the first dead end 23. The jaw plate clamping bar recess 20 is adapted to receive the fastening means 50 for the jaw plate clamping bar 10, which fastening means comprises at least one pin with a head, which pin head is adapted to abut against the shoulder 22 of the recess 20. Moreover, the pin of the fastening means 50 protrudes out of the recess 20 passing the side of the shoulder 22 facing the rear face 12, 13, 14 where the width of the recess is smaller, i.e. the width of the recess on the other side of the shoulder where the pin head is arranged is larger compared to the side through which the pin protrudes.

The jaw plate part/clamping bar 10 may comprise a longitudinal end or joint 25 between ends of two jaw plate parts/clamping bars when two jaw plate parts are used for making up a two-part divided jaw plate part in the longitudinal direction. The jaw plate part/clamping bar 10 may comprise jaw plate part/clamping bar end 26 for placement at the sides or cheeks of the crushing chamber 30 of the crusher 1, which end is shaped as a shoulder to be fitted against an edge of the crusher, the jaw plate 2, 2′ or the jaw 3, 3′ for hindering unwanted movement/travelling of the jaw plate parts or clamping bars 10 in their longitudinal direction, which direction is angled or perpendicular to the feeding direction of the material to be crushed and/or the vertical direction through the crusher, due to vibrations and the like when the crusher operates.
1 jaw crusher
2 moving jaw plate
2′ stationary jaw plate
3 moving jaw
3′ stationary jaw
4 upper (slanted) wedge defining surface of jaw crusher
5 lower (slanted) wedge defining surface of jaw crusher
10 jaw plate part/clamping/wedging bar
11 front of jaw plate part/clamping bar
12 rear of jaw plate part/clamping bar
13 bottom of jaw plate part/clamping bar
14 top of jaw plate part/clamping bar
20 recess in jaw plate part/clamping bar
21 first opening of recess in jaw plate part/clamping bar
21′ second opening of recess in jaw plate part/clamping bar
22 shoulder of recess in jaw plate part/clamping bar
23 first dead end of recess 20
24 second dead end of recess 20
25 longitudinal end or joint between two jaw plate parts/clamping bars
26 jaw plate part/clamping bar end for fitting at crusher chamber sides
30 crushing chamber/gap
40 crusher frame
50 fastening means for jaw plate part/clamping bar
C centre axis of fastening means 20
α angle between portion 13 and portion 14
A arrow showing directions of movement of clamping/wedging bar 10
B arrow showing direction of extension of fastening means 50

1. A jaw plate part for securing a jaw plate to a jaw of a jaw crusher, the jaw plate part being arranged to work as a wedge being detachable from the jaw crusher, the jaw plate part comprising a front face and a rear face the rear face of the jaw plate part including at least one recess having a first dead end, the recess, in at least one region, including a shoulder, wherein a width of the recess at least closest to the shoulder on a side of the shoulder facing the first dead end is larger than the width of the recess at least closest to the shoulder on a side of the shoulder facing the rear face.

2. The jaw plate part according to claim 1, wherein the first dead end of the recess of the jaw plate part ends at a distance from the front face.

3. The jaw plate part according to claim 1, wherein the recess of the jaw plate part is a groove extending along the rear face with its first dead end located at a distance from the front face.

4. The jaw plate part according to claim 1, wherein the width of the recess of the jaw plate part on the side of the shoulder facing the dead end is larger than the width of the recess on the side of the shoulder facing the rear face.

5. The jaw plate part according to claim 3, wherein the groove of the jaw plate part includes two ends defining the length of the groove, wherein one of the groove ends is a second dead end.

6. The jaw plate part according to claim 5, wherein the other end of the groove of the jaw plate part is an open end.

7. The jaw plate part according to claim 1, wherein the recess of the jaw plate part is arranged to receive a fastening means for the jaw plate part, the fastening means comprises one pin with a head, wherein the shoulder acts as an abutment for the pin head.

8. The jaw plate part according to claim 7, wherein the pin head is arranged in the recess of the jaw plate part on the side of the shoulder facing the first dead end where the width of the recess is larger.

9. The jaw plate part according to claim 7, wherein the pin of the fastening means protrudes out of the recess of the jaw plate part in a direction not being in parallel with the lengthwise extension of the recess.

10. The jaw plate part according to claim 9, wherein the pin protrudes out of the recess of the jaw plate part passing the side of the shoulder facing the rear face where the width of the recess is smaller.

11. The jaw plate part according to claim 7, wherein the recess of the jaw plate part on the side of the shoulder facing the first dead end has a fit in relation to the pin head creating a rotational lock for the pin head.

12. The jaw plate part according to claim 1, wherein the front face of the jaw plate part is a fully covered surface.

13. The jaw plate part according to claim 1, wherein the front face of the jaw plate part is smooth where the jaw plate part faces a crusher chamber of the jaw crusher.

14. A jaw plate part according to claim 1, wherein the jaw plate part is a jaw plate clamping bar.

15. A jaw plate part unit comprising:
at least one jaw plate part for securing a jaw plate to a jaw of a jaw crusher, the jaw plate part being arranged to work as a wedge being detachable from the jaw crusher, the jaw plate part including a front face and a rear face, the rear face of the jaw plate part including at least one recess having a first dead end, the recess, in at least one region, including a shoulder, wherein a width of the recess at least closest to the shoulder on a side of the shoulder facing the first dead end is larger than the width of the recess at least closest to the shoulder on a side of the shoulder facing the rear face; and
fastening means.

16. A jaw crusher comprising at least one jaw plate part unit for securing jaw plates of the jaw crusher, the at least one jaw plate part unit including at least one jaw plate part for securing a jaw plate to a jaw of the jaw crusher, the jaw plate part being arranged to work as a wedge being detachable from the jaw crusher, the jaw plate part including a front face and a rear face, the rear face of the jaw plate part including at least one recess having a first dead end, the recess, in at least one region, including a shoulder, wherein a width of the recess at least closest to the shoulder on a side of the shoulder facing the first dead end is larger than the width of the recess at least closest to the shoulder on a side of the shoulder facing the rear face, and fastening means.

17. A jaw plate part according to claim 1, wherein the jaw plate part is arranged to be used in combination with at least one jaw plate clamping bar
